(19) United States
(12) Patent Application Publication
(10) Pub. No.: US 2006/0112798 A1
(43) Pub. Date: Jun. 1, 2006

(54) Method for releasing slug after punching, and punching machine

(76) Inventors: Marcel Hermanus Johannes Rensen, Arnhem (NL); Henri Joseph Van Egmond, Emmerich am Rhein (DE); Adrianus Wilhelmus Van Dalen, Nijmegen (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/538,545

(22) PCT Filed: Dec. 4, 2003
(86) PCT No.: PCT/NL03/00863

§ 371 Date: Dec. 5, 2005

(30) Foreign Application Priority Data
Dec. 10, 2002 (NL) 1022122

(51) Int. Cl. B26D 1/00

(52) U.S. Cl. 83/13

(57) ABSTRACT

The invention relates to a method for releasing a slug adhering to a stamp in a punching machine, by carrying the stamp, after performing a punching operation on a sheet material, with the active stroke at least partially through a cutting opening in a cutting plate supporting the sheet material, and carrying the stamp during the return stroke back again through the cutting opening in the cutting plate which close-fittingly encloses the stamp. The invention also relates to a punching machine for releasing the slug adhering to a stamp according to this method.

The present invention relates to a method for releasing slug adhering to a stamp in a punching machine as according to the preamble of claim 1. The invention also relates to a punching machine for releasing slug adhering to a stamp as according to the preamble of claim 8.

The punching or cutting of thin sheet material that functions as carrier of electronic components is much applied, particularly in the production of semiconductors. The carrier (leadframe) can herein consist of a thin metal layer, although it is also possible for the carrier to be a multilayer construction containing ceramic and/or plastic. The parts to be punched out of the sheet material are usually of very limited dimensions (in the order of magnitude of tenths of a millimetre), and during the punching considerable forces are exerted locally on the sheet material (in the order of magnitude of thousands of kg per cm²). These factors have the result that punched-out or cut-out sheet parts (referred to as “slug”) remain adhered to the stamp after removal from the sheet material. A problem which can occur here is that during a return stroke of the stamp the slug can be at least partially carried back again into the sheet material, with the consequence of problems in the further processing of the carrier with electronic components. Another problem is that slug can accumulate below the level at which the carrier is located such that punching of subsequent sheet material can thereby be disrupted.

Many solutions are known in the prior art for controlled discharge of slug after the performing of a punching operation. The European patent application 1 066 932 thus describes a mould construction wherein an elastic layer is provided which covers the cutting opening in the mould on the underside. Included in this elastic layer is a hole with a diameter smaller than the diameter of a stamp. The hole is stretched during passage of the stamp with adhered slug. As soon as the slug has passed through the elastic layer, the diameter of the hole in the elastic layer will decrease again. During the return stroke of the stamp the elastic layer will close tightly round the stamp and thus scrape the slug from the stamp.

The object of the present invention is to provide an improved method and punching machine of the type stated in the preamble with which certainty can be provided in relatively simple manner in respect of separating slug and stamp. The invention provides for this purpose a method for releasing slug adhering to a stamp in a punching machine as according to the claim 1. The method according to the invention is based on the insight that a punched-out sheet part will expand when it is not wholly surrounded at the position where the slug was originally connected to the remaining part of the sheet material or by a cutting opening clampingly enclosing the sheet material. During the punching operation considerable forces are exerted whereby the sheet material is subjected, among other things, to (limited) plastic compression. After the thus compressed material is released, it will return to a more original (expanded) form. Use is now made of this (small) enlargement of the punched-out sheet part. After the slug has been carried at least partially through the cutting opening, the described expansion will take place. As the cutting opening engages close-fittingly round the stamp, the expanded slug will no longer move back with the stamp in the cutting opening during the return stroke; the edge of the cutting opening serves to hold back the edge of the expanded slug projecting from the stamp. This therefore results in the certainty that the slug is not carried back to the processed material layer. In contrast to the present invention, use is made in the most approximate prior art of deformation of a resilient material layer assembled with the punching device; this differs expressly from the insight according to the present invention wherein use is made of the deformation of the slug. Other than in the described prior art, a deformable elastic layer is unnecessary in the method according to the invention. Such a layer being unnecessary is advantageous, among other reasons, because such a layer is relatively susceptible to wear and has the drawback of forming a source of contamination.

In a particularly advantageous application of the method, the stamp is carried through the cutting opening in the cutting plate during the punching operation such that the periphery of the slug adhering to the stamp is released over only a part of the periphery from the cutting plate. It has been found possible in practice to achieve unexpectedly favourable results in respect of releasing the slug from the stamp when only a part of the periphery thereof is released from the cutting plate. The reason herefor is that, when it is completely released from the cutting plate, the slug has the possibility of repositioning itself (it can take up a changed position) relative to the stamp. This process of repositioning is found to take place under the influence of magnetism. After repositioning it is possible that the slug no longer lies completely flat against the stamp and is thus carried back into the cutting plate, and possibly the sheet material. When the slug is released over only a part of the periphery from the cutting plate, the chance of repositioning of the slug is considerably reduced. This is found to be particularly the case when the slug remains in contact with the cutting plate on at least two sides. The slug can thus remain surrounded, thereby making repositioning impossible.

The stamp is preferably carried through the cutting opening in the cutting plate during the punching operation such that the periphery of the slug adhering to the stamp is wholly released from the cutting plate. There is then no possibility of the slug being held fast by the cutting opening. It is however possible to envisage that the scraping edge of the cutting opening on the side remote from the sheet material is at an angle to the plane through the material layer. With such a geometry of the cutting opening it is also conceivable for the slug not to be completely released from the cutting plate but only over a substantial part of the periphery of the slug. The effect sought, of expanded slug being held back by the scraping edge of the cutting opening, can already be achieved in this manner.

It is noted expressly that a punching operation is also understood to mean a cutting operation or similar process in which a sheet part is forced out of a larger whole using a stamp. Another advantage of the method according to the invention is that the method can be performed in relatively simple manner with existing equipment; the movement of the stamp corresponds at least substantially with the movement of the stamp in a prior art punching machine. Attention does however have to be paid here that the stamp is carried sufficiently far through the cutting opening. Only the dimensions of stamp and cutting plate have to be adapted to each other, and these components are usually product-dependent, so that introduction of the method does not require any considerable investment in the production means.

The slug released from the stamp is preferably discharged further, for instance by means of gravity and/or supported by airflow. The return stroke is preferably continued so far that the cutting opening in the cutting plate and the sheet material are left clear by the stamp so that the processed sheet material can be taken from the cutting plate, and a new material sheet can be placed on the cutting plate before commencing a subsequent punching operation.

The invention also provides a punching machine for releasing slug adhering to a stamp, comprising: a cutting plate provided with at least one cutting opening, at least one stamp for linear intermittent displacement, which is displaceable between a position in which the cutting opening in the cutting plate is left clear by the stamp and a position in which the stamp is carried through the cutting opening, characterized in that the stamp passes close-fittingly through the cutting opening of the cutting plate. The free space between the stamp and the associated cutting plate in the position where the stamp is carried through the cutting opening is herein smaller than 0.02 mm, more preferably smaller than 0.01 mm (a free space is usually applied of about 5% of the thickness of the material for cutting, this process being applied particularly for processing sheet material with a thickness up to 1 mm). With such a punching machine the advantages can be realized as already described above with reference to the method according to the present invention.

The cutting plate is preferably adapted to support a material layer for processing, and the edge of the cutting opening on the side remote from the side supporting the material layer is sharp. The sharp edge can herein run parallel to the side supporting the material layer, although it is also conceivable for the scraping edge of the cutting opening to enclose an angle with the support surface for the material layer. When the edge of the cutting opening on the side remote from the side supporting the material layer at least locally encloses an angle with a cutting edge of the stamp, repositioning of the slug relative to the stamp can be prevented. The advantages hereof have already been described above.

In a preferred variant the cutting plate is supported by a punch plate with a passage for slug connecting onto the cutting opening in the cutting plate, which passage is larger than the cutting opening. The cutting plate (usually manufactured from a hard metal) can thus have a limited size. It is also possible here for a single punch plate to support a plurality of separate cutting plates. When the cutting plate is now connected releasably to the punch plate, it is possible to detach a cutting plate from the punch plate for repair or maintenance purposes. In the case a plurality of cutting plates are fixed to a single punch plate, this is also advantageous when there is damage to a cutting plate; only one cutting plate (of relatively small size) then has to be replaced while the still functioning cutting plates can be retained.

For the further discharge of slug, suction means and/or blowing means can connect onto the cutting opening. The punching machine can comprise drive means in the usual manner for the linear intermittent displacement of the stamp.

The present invention will be further elucidated with reference to the non-limitative embodiments shown in the following figures, wherein:

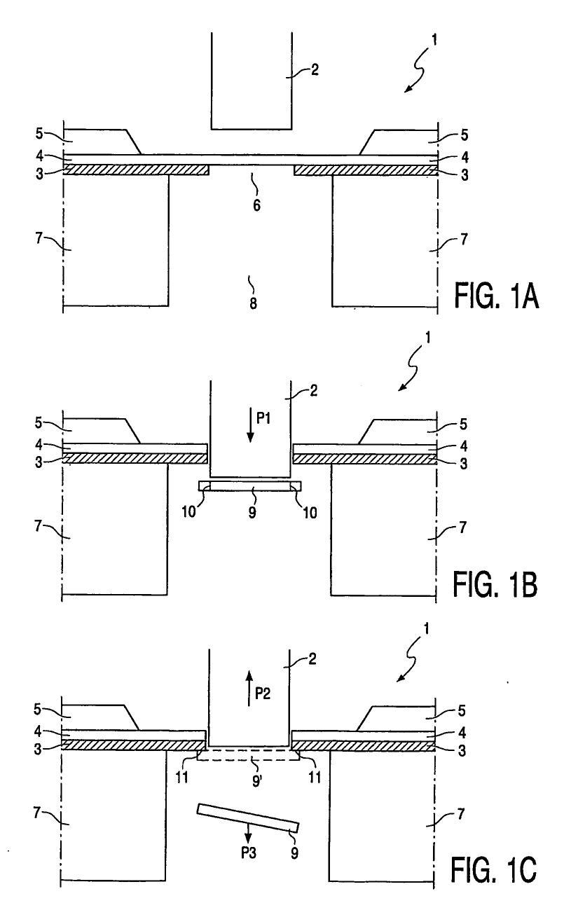

FIG. 1A shows a schematic cross-section through a part of a punching device according to the invention and a material layer for processing prior to the start of the punching operation,

FIG. 1B shows the cross-section of FIG. 1A after a punching stroke has been performed,

FIG. 1C shows the cross-section of FIGS. 1A and 1B during a return stroke of the punching device,

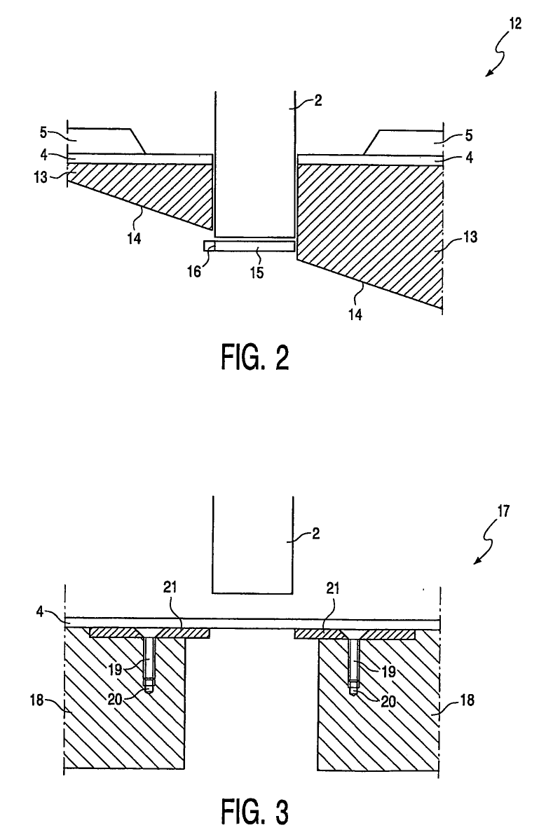

FIG. 2 shows a schematic cross-section through a part of an alternative embodiment variant of the punching device according to the invention after a punching stroke has been performed,

FIG. 3 shows a schematic cross-section through a part of a second alternative embodiment variant of the punching device according to the invention prior to the start of the punching operation, and

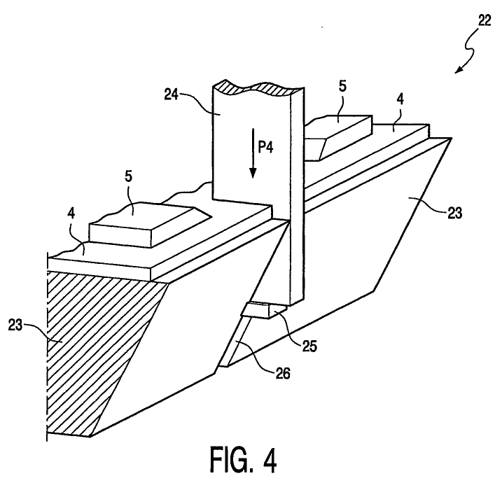

FIG. 4 is a perspective view of a part of a third alternative embodiment variant of the punching device according to the invention during the punching operation.

FIG. 1A shows a part of a punching device 1 with a stamp 2 which is situated above a cutting plate 3. Lying on cutting plate 3 is a material layer 4 for processing which is provided with encapsulated electronic components 5. Left clear in cutting plate 3 is a cutting opening 6 which is only very slightly larger than the largest periphery of stamp 2. Cutting plate 3 is supported by a punch plate 7 in which, under cutting opening 6, a passage 8 is left clear which has a clearly larger dimension than cutting opening 6.

FIG. 1B shows the part of punching device 1 shown in FIG. 1A, now however after stamp 2 has performed a punching stroke as shown by means of arrow P1. Through co-action of stamp 2 and the cutting opening 6 in cutting plate 3 during the punching stroke, a material part (also referred to as slug) 9 is punched (or cut) out of material layer 4. A particular effect during the punching operation is that after being released from cutting plate 3 the slug 9 expands to a limited extent. The original dimensions of slug 9, i.e. the dimension of slug 9 while still partially surrounded by material layer 4 or cutting plate 3, is shown by means of the dotted lines 10. Slug 9 can release spontaneously from stamp 2 but, due to the great force exerted by stamp 2 on material layer 4 during the punching, it also occurs frequently that slug 9, as shown, remains adhered to stamp 2. This adhesion of slug 9 to stamp 2 is undesirable.

FIG. 1C once again shows the already shown part of punching device 1, now however during performing of the return stroke of stamp 2 indicated by means of arrow P2. Stamp 2 is moved upward. The expanded part of slug 9 herein comes into contact with an edge 11 of cutting opening 6. Slug 9 is held back in the situation as indicated by means of the slug 9′ shown in broken lines, and then drops downward as according to arrow P3.

FIG. 2 shows a view of a part of a punching device 12 with a differently embodied cutting plate 13. The side 14 of cutting plate 13 remote from material layer 4 does not run parallel to material layer 4. The side 14 of cutting plate 13 is formed such that slug 15 does not have to be pressed completely outside of cutting plate 13 in order to be able to make use of the expansion of slug 15. In the shown situation expansion of slug 15 can already take place (see dotted line 16 for the original dimension of slug 15). When stamp 2 is moved back from the shown situation, slug 15 will already be held back.

FIG. 3 shows yet another variant of a punching device 17 with a punch plate 18 on which detachable cutting plates 21 are fixed by means of screws 19 and openings 20 arranged in punch plate 18. In this variant the punch plate 18 also partly supports the material layer 4.

Finally, FIG. 4 shows a further variant of a punching device 22 with a punch plate 23 in which is arranged a cutting opening open on one side. A stamp 24 passes through the cutting opening. Stamp 24 presses a slug 25 as according to arrow P4 through a chamfered groove 26 placed connecting onto the cutting opening. Slug 25 has to be displaced so far through groove 26 that the desired effect of a blocked return of slug 25 through groove 26 is obtained because of expansion of a part of slug 25.

1-17. (canceled)

18. A method for releasing a slug adhering to a stamp in a punching machine, by carrying the stamp, after performing a punching operation on a sheet material, with the active stroke at least partially through a cutting opening in a cutting place supporting the sheet material, and carrying the stamp during the return stroke back again through the cutting opening in the cutting plate which close-fittingly encloses the stamp,
wherein the cutting opening functions during the return stroke such that the side of the cutting plate remote from the sheet material engages around the cutting opening as a scraping edge on the slug adhering to the stamp and releases it from the stamp.

19. The method as claimed in claim 18, wherein the stamp is carried through the cutting opening in the cutting plate during the punching operation such that the periphery of the slug adhering to the stamp is released over only a part of the periphery from the cutting plate.

20. The method as claimed in claim 18, wherein the stamp is carried through the cutting opening in the cutting plate during the punching operation such that the periphery of the slug adhering to the stamp is wholly released from the cutting plate.

21. The method as claimed in claim 18, wherein the return stroke of the stamp is continued so far that the cutting opening in the cutting plate and the sheet material are left clear by the stamp.

22. The method as claimed in claim 21, wherein after the sheet material has been left clear by the stamp, the processed sheet material is removed from the cutting plate.

23. The method as claimed in claim 18, wherein a sheet material for processing is placed on the cutting plate before commencing the punching operation.

24. The method as claimed in claim 18, wherein the slug released from the stamp is discharged.

25. A punching machine for releasing a slug adhering to a stamp, comprising:
a cutting plate provided with at least one cutting opening,
at least one stamp for linear intermittent displacement which is displaceable between a position in which the cutting opening in the cutting plate is left clear by the stamp and a position in which the stamp is carried through the cutting opening, and
wherein the stamp passes close-fittingly through the cutting opening of the cutting plate, wherein the cutting opening in the cutting plate has a scraping edge for releasing the slug adhering to the stamp.

26. The punching machine as claimed in claim 25, wherein the free space between the stamp and the associated cutting plate in the position where the stamp is carried through the cutting opening is smaller than 0.02 mm.

27. The punching machine as claimed in claim 25, wherein the cutting plate is adapted to support a material layer for processing, and the edge of the cutting opening on the side remote from the side supporting the material layer is sharp.

28. The punching machine as claimed in claim 25, wherein the edge of the cutting opening on the side remote from the side supporting the material layer at least locally encloses an angle with a cutting edge of the stamp.

29. The punching machine as claimed in claim 25, wherein the cutting plate is supported by a punch plate with a passage for the slug connecting onto the cutting opening in the cutting plate, which passage is larger than the cutting opening.

30. The punching machine as claimed in claim 29, wherein the punch plate supports a plurality of separate cutting plates.

31. The punching machine as claimed in claim 29, wherein the cutting plate is connected releasably to the punch plate.

32. The punching machine as claimed in claim 25, wherein suction means connect onto the cutting opening for discharge of the slug.

33. The punching machine as claimed in claim 25, wherein blowing means connect onto the cutting opening for discharge of the slug.

34. The punching machine as claimed in claim 25, wherein the punching machine comprises drive means for the linear intermittent displacement of the stamp.
